(19) United States
(12) Patent Application Publication
(10) Pub. No.: US 2018/0363773 A1
(43) Pub. Date: Dec. 20, 2018

(54) CONTROL LEVER

(71) Applicant: GM GLOBAL TECHNOLOGY OPERATIONS LLC, Detroit, MI (US)

(72) Inventors: Yogesh Sadashiv Nirgude, Bangalore (IN); Hans-Juergen Burger, Nauheim (DE)

(73) Assignee: GM GLOBAL TECHNOLOGY OPERATIONS LLC, Detroit, MI (US)

(21) Appl. No.: 15/981,384

(22) Filed: May 16, 2018

(30) Foreign Application Priority Data
May 16, 2017 (DE) 102017004653.0

(51) Int. Cl. F16H 61/22; F16H 59/02; F16H 59/10

(52) U.S. Cl. CPC F16H 61/22; F16H 2059/0282; F16H 59/10; F16H 59/0278

(57) ABSTRACT

A control lever for a vehicle includes a lever shaft, a knob and a locking element for locking the knob on the lever shaft. The lever shaft defines a longitudinal axis. The knob has an axially extending recess in which a tip of the lever shaft is fittingly received. The lever shaft has a shoulder which faces away from the tip. The locking element has at least one leg which is elastically held in a first position overlapping the shoulder and which is connected to the knob so as to be displaceable in a first radial direction from the first position to an second position in which the leg and the shoulder do not overlap each other. The locking element further has an actuation section for controlling the displacement of the leg, which is accessible on an outer side of the knob.

### CROSS-REFERENCE TO RELATED APPLICATION

This application claims priority to German Patent Application No. 102017004653.0, filed May 16, 2017, which is incorporated herein by reference in its entirety.

### TECHNICAL FIELD

The present disclosure pertains to a control lever for a vehicle, and more particularly to a gearshift lever for controlling a manual transmission in a motor vehicle.

### BACKGROUND

A conventional gearshift lever has a lever shaft, a knob and a locking element for locking the knob on the shaft. The knob has a recess which extends in the axial direction of the shaft and fittingly receives a tip of the shaft. The locking element is typically a ring which is held in a circumferential groove formed in the wall of the recess and has a plurality of inwardly extending elastic projections. When the knob is slipped onto the lever shaft, these projections are first compressed in an outward direction. Once the projections have passed the shoulder, they expand again and engage behind the shoulder. If the tolerances between the knob and the shaft lever are large, all the projections securely pass the shoulder and expand again, but in this case an undesirable axial clearance will likely remain between the shaft and the knob. If the tolerances are low, not all protrusions may expand again. In this case, the connection between the shaft and the knob may be unreliable. If such an incomplete locking of the knob on the shaft is detected during the assembly process, the knob must be removed. This is a complex process, which generally leads to destruction of the locking element.

### SUMMARY

In accordance with the present disclosure a control lever is provided in which an incomplete locking of the knob on the shaft can be repaired in a rapid and appropriate manner.

According to an embodiment of the present disclosure, a control lever for a vehicle includes a lever shaft, a knob and a locking element for locking the knob on the shaft. The lever shaft defines a longitudinal axis and the knob has an axially extending recess in which a tip of the shaft is fittingly received. The shaft has a shoulder which faces away from the tip, the locking element has at least one leg which is elastically held in a first position overlapping with the shoulder and is connected to the knob so as that it is displaceable in a first radial direction from the first position into a second position in which the leg and the shoulder do not overlap with each other such that the knob is unlocked from the shaft. The locking element has an actuation section for controlling the displacement of the leg, which is accessible on the outside of the knob.

The simplest way to actuate the actuation section would be to push it radially inward. However, this would mean that the actuation section would have to protrude far enough from the shaft in the non-actuated state to allow the unlocking displacement, and that it should be ensured that the actuation section cannot be pressed unintentionally by the driver while driving. According to a preferred embodiment, the actuation section is therefore in the second position further away from the lever shaft than in the first position, so that it must be pulled into the second position for unlocking the knob on the actuation section.

The knob may have a conical surface which overlaps the shoulder in the axial direction and which can displace the leg to the second position when the knob is slipped onto the shaft without having to actuate the actuation section. The shoulder and conical surface may form a rib that extends around the axis of the shaft. In practice, the shaft may include an elongate core and a sleeve which is fastened to the core by snapping, screwing or otherwise. The shoulder is formed by an end of the sleeve.

The knob may have a groove for receiving the leg, which is open in the first radial direction and is elongated in a second radial direction. Such an arrangement makes it possible to control the overlap between the leg and the shoulder by displacing the leg in the second radial direction. The radial displacement of the leg, by which the knob is unlocked, can be facilitated by the knob having at least one inclined surface which extends in a direction between the first and second radial directions and which, at least after the displacement of the actuation section in the second radial direction, is in contact with the leg.

The knob may have two such inclined surfaces facing in opposite directions so that, by contact with one of them, the leg may be forced in that way to overlap with the shoulder, while through contact with the other, the overlap can be reversed. Most favorably, these two inclined surfaces are sides of a slot in which the leg engages. To facilitate the displacement and prevent wearing of the inclined surface through scratching, the leg may have an axially extending section which works together with the inclined surface.

The locking element may also serve as a spring element that tends to bring the legs back to the locking position when released by elastically bending them by displacement from the first position to the second position. Most conveniently, the locking element has two legs which overlap diametrically opposite regions of the shoulder in the first position. The elastic displacement of the at least one leg is facilitated when the locking element is U-shaped. In this case, an intermediate section which connects the two legs of the U-shape with each other can serve as an actuation section.

The actuation section may extend through an axially extending groove which is formed on the outside of the knob. The groove facilitates the insertion of a tool by which the locking element can be forced into the second position, even if the locking element outside the groove is in direct contact with the knob or when it engages in a radially extending groove which is formed thereon.

The locking element may be a metal wire.

Although a gearshift lever may represent a preferred embodiment of the present disclosure, it will be apparent to those skilled in the art that the principles described herein are directly applicable to other types of control levers, such as actuation levers for windshield wipers or blinkers.

### BRIEF DESCRIPTION OF THE DRAWINGS

The present disclosure will hereinafter be described in conjunction with the following drawing figures, wherein like numerals denote like elements.

FIG. 1 is a perspective view of a shift arrangement for a manual transmission;

FIG. 2 is an enlarged view of the gearshift lever of the arrangement;

FIG. 3 is an axial section of the gearshift lever in disassembled state;

FIG. 4 is an axial section of the gearshift lever in assembled state;

FIG. 5 is a view of a locking element of the gearshift lever; and;

FIG. 6 shows a knob of the gearshift lever in a perspective view from below.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

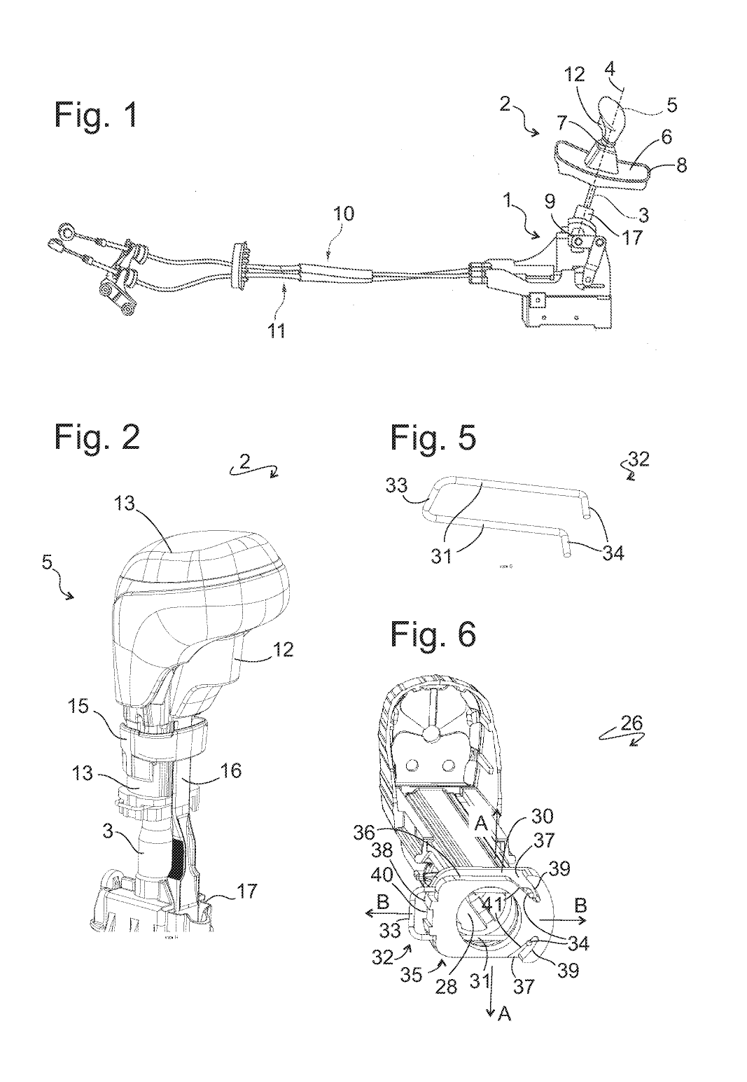

FIG. 1 shows a transmission shifting arrangement of a motor vehicle in a side view. A housing 1 of the arrangement is configured to be mounted in a center tunnel (not shown) between the front seats of the motor vehicle such that, while the housing 1 is hidden in the center tunnel, a shift lever 2 protrudes upwardly out of the housing 1 and through an opening of the center tunnel to be accessible to the driver. The shift lever 2 includes a lever shaft 3 having a proximal end mounted in the housing 1 and a distal end. The lever shaft 3 defines an axis 4 that extends between the distal and proximal ends. A knob 5 is slipped on the distal end of the lever shaft 3. A flexible boot 6 includes a narrow central opening 7, through which the lever shaft 3 extends and to which it is attached, and a peripheral edge 8 which is attached to the central tunnel in order to seal the opening.

The shift lever 2 is pivotally mounted in the housing 1 by a movable connection 9, for example a ball joint. As is conventional in the art, the housing 1 includes a shifting gate, not shown, which limits the freedom of movement of the shift lever 2, allowing it to be pivoted in a first direction only along a plurality of mutually parallel shifting slots and to be moved from one shifting slot to the other along a selection slot which extends perpendicular to the shifting slots.

The movements of the shift lever 2 along the shifting and selection slots are transmitted by cables 10, 11 to a gearbox, not shown, so that when the shift lever 2 reaches a dead end of a shifting slot, a gear associated with this dead end is engaged in the gearbox.

One of these gears is a reverse gear. Since it may not be inadvertently engaged while the vehicle is in rapid forward motion, the access of the shift lever 2 to shifting slot leading to the reverse gearshift is usually blocked such that access to that particular shifting slot is enabled when a button 12 on the knob 5 is pressed.

FIG. 2 is an enlarged view of the shift lever 2. The knob 5 includes a rounded handle section 13 and a tubular section 14 which extends from the handle section 13 in the direction of the housing 1. The tubular section 14 is in engagement with a distal end section of the shaft 3. A ring element 15 is mounted on the tubular section 14 immediately below the handle section 13. When the shift lever 2 is installed in the vehicle, the boot 6 (not shown in FIG. 2) is attached to the ring element 15 so that a lower region of the tubular section 14 and the shaft 3 are hidden from sight by the boot 6.

The knob 12 is connected by an axially extending rod 16 to a blocking element 17 which extends around the lever shaft 3 near its proximal end. Conventionally, the blocking element 17 includes a rib which, when the lever shaft 3 is displaced in the selection slot while the knob 12 is not actuated, abuts against a corresponding rib of the housing 1 before the lever shaft 3 reaches the shifting slot which leads to the reverse gear. By pushing the button 12 upwards, the driver can lift the blocking element 17 so far that the ribs of the blocking element 17 and the housing 1 cease to overlap, by which the shifting slot of the reverse gear is made accessible.

Since the blocking element 17 is rigidly coupled to the knob 12, access to the shifting slot of the reverse gear can be reliably blocked and released only when the axial position of the knob 5 on the lever shaft 3 is precisely defined. If the knob 5 is too far away from the proximal end of the lever shaft 3, the overlapping of the ribs of the blocking element 17 and the housing 1 may be too low, so that access to the shifting slot of the reverse gear may not be blocked even though the knob 12 is not actuated. If the knob 5 is too close to the proximal end, pressing the button 12 may not be enough to release access to the shifting slot of the reverse gear. The present disclosure ensures that the knob 5 is correctly which is placed by means of a locking mechanism which will be described below.

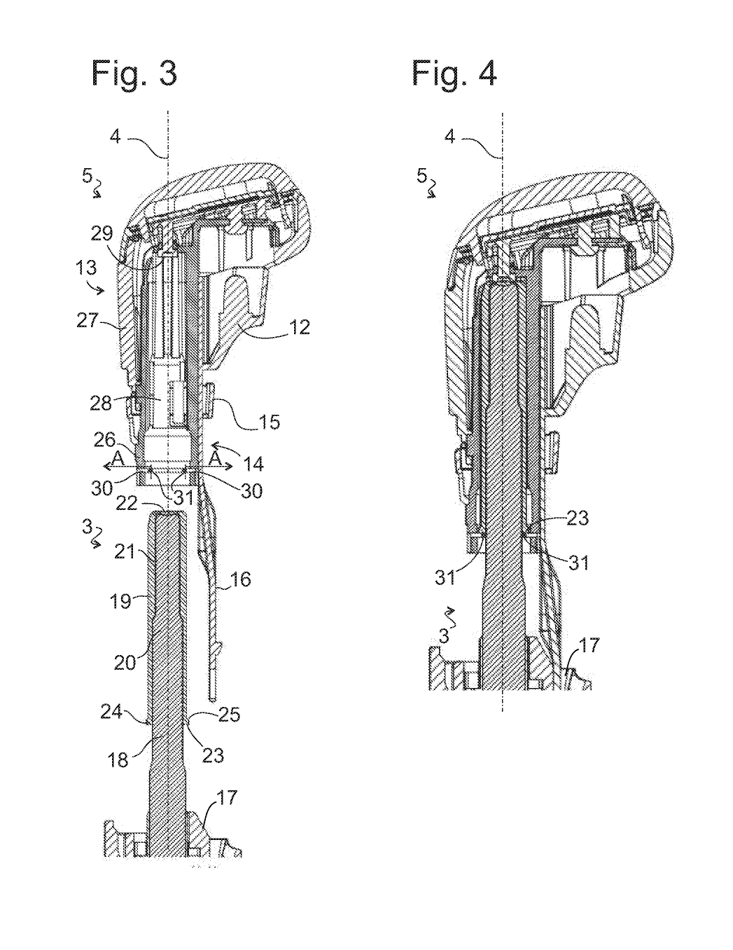

FIG. 3 shows the lever shaft 3 and the knob 5 of the shift lever 2 in a cross section along the axis 4 and in a separated or expanded state. The lever shaft 3 includes a metal core element 18 which includes the proximal end of the shift lever 2, not shown, connected to the hinge 9, and a plastic tube 19 which is mounted on a distal end section 20 of the core element 18. A part of the end section 20 has a corrugated profile 21, which may be a thread on which the tube 19 is screwed until the upper tip of the core element 18 comes against an upper wall 22 of the tube 19. Under the corrugated profile 21, the tube 19 is placed tightly on the core element 18. The lower end of the tube 19 forms a shoulder 23 which faces the proximal end of the shift lever. A rib 24, which extends around the tube 19 near its lower end, has a conical upper surface 25.

The knob 5 includes a core element 26 which is injection molded from a rigid plastic material and which forms the majority of the tubular section 14, and a sheath 27 of a softer plastic material which is formed on the core element 26 and forms a major part of the surface of the handle section 13. The core element 26 has a tubular recess 28 which is shaped such that it abuts tightly against the tube 19 of the lever shaft 3. At the upper end of the recess 28 is a passage through which a projection 29 of the sheathe 27 extends into the recess 28 to form an elastic stop for the tip of the lever shaft 3.

Near its lower end, the tubular section 14 has two grooves 30 which extend perpendicular to the cross-sectional plane of FIG. 3 and the axis 4 and whose openings are facing away from the axis 4 in the radial direction. A central part of each groove 30 intersects the tubular recess 28. Each groove 30 receives a leg 31 of a U-shaped locking element made of elastic wire. The locking element is prestressed so that the legs 31 press against the bottom of their respective grooves 30, wherein a part of the legs 31 extend through the recess 28.

When the knob 5 is placed on the lever shaft 3, the legs 31 come into contact with the conical top 25 of the rib 24. When the lever shaft 3 further penetrates into the recess 28, the legs 31 are spread by the top 25 in a first radial direction A. Once the rib 24 has passed the grooves 30, the legs 31 approach each other again and lock the knob in its position by contact with the shoulder 23, as shown in FIG. 4.

FIG. 5 is a perspective view of the locking element 32. The two legs 31 are straight and extend parallel to each other. They are connected by an arc-shaped intermediate section. For reasons that will become apparent later with reference to FIG. 6, this intermediate section is also referred to as the actuation section 33. At the ends of the legs 31, which are opposite to the actuation section 33, angled sections 34 are formed, which extend in a direction perpendicular to the plane which is defined by the legs 31 and the actuation section 33.

FIG. 6 is a perspective view of the core element 26 of the knob 5 seen from below. The core element 26 has a lower section 35 of approximately cuboid shape. One of the grooves 30 extends horizontally over most of a surface of the cuboid lower section 35, which in the orientation in which the shift lever 2 is installed in the vehicle would be a back 36 visible in FIG. 6, while the other groove extends in a front side of the lower section 35, which faces away from the viewer in FIG. 6. The groove 30 of the front side is not visible in FIG. 6, while a part of the leg 31, which extends through the crossing region of the groove 30 and the tubular recess 28, is very visible. At their right ends, the grooves 30 reach slots 37 which extend approximately circumferentially with respect to the axis 4 and receive the angled sections 34 of the locking element 32.

During the mounting of the shift lever, the legs 31 are spread apart from each other in a first radial direction A by the rib 24 of the lever shaft 3 going through them, the angled sections 34 are pressed against the outer sides 39 of the slots 37 in the direction A, whereby the locking element 32 is displaced in a second radial direction B, which is perpendicular to the direction A, and the actuation section 33 is spaced from a left side surface 38 of the lower section 35.

In this position, the actuation section 33 can be pushed in direction B against the side surface 38. When this happens, the angled sections 34 are pressed in direction B against the outer sides 39 of the slots 37. Since the slots 37 are aligned between the directions A and B and converge in the pressing direction, the legs are forced to approach each other in direction A. In this way, the legs 31 can be forced to engage behind the shoulder 23, even if the rib 24 has not yet fully passed the grooves 30, thereby ensuring that the knob 5 is securely locked to the lever shaft 3. By compressing the projection 29, an axial clearance between the knob 5 and the lever shaft 3 is completely avoided.

The friction between the legs 31 and the shoulder 23 may cause the locking element 32 to get stuck in the position taken in this way. On the side surface 38 is an axially extending groove 40, which the actuation section 33 cannot block, even if it is on both sides of the groove 40 in direct contact with the side surface 38. Therefore, if necessary, the actuation section 33 can be pulled away from the side surface 38 by inserting a sharp tool such as a screwdriver into the groove 40.

By pulling the actuation section 33 away from the axis 4 in direction B, the angled sections 34 are brought into contact with the inner sides 41 of the slots 37 and thus forced away from each other in direction A. Therefore, by pulling the actuation section 33 far enough, the legs 31 can be completely removed from the crossing region between the grooves 30 and the tubular recess 28, whereby the knob 5 is unlocked from the lever shaft 3 and can be removed without being damaged.

According to an alternative embodiment, the orientation of the slots may be divergent in the pressing direction. In this case, the actuation section 33 is pulled to force the legs 31 to engage below the shoulder 23, while pushing or pressing the actuation section 33 would release the knob. However, the embodiment of FIG. 6 is preferred, since here the more frequent operation can be performed without tools.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. A control lever for a vehicle, comprising:
a lever shaft defining a longitudinal axis and having a free end and a shoulder which faces away from the free end;
a knob an axially extending recess to fittingly receive the free end of the lever shaft; and
a locking element configured to releasably secure the knob on the lever shaft, the locking element having at least one leg which is elastically held in a first position engaging the shoulder to secure the knob and the lever shaft and an actuation section accessible on an outer side of the knob for manipulating the leg, wherein displacement of the actuation section moves the leg in a first radial direction from the first position to an second position in which the leg disengages from the shoulder.

17. The control lever according to claim 16, wherein displacement of the actuation section away from the lever shaft such that the actuation section is further from the lever shaft in the second position than in the first position.

18. The control lever according to claim 16, wherein the knob further comprises a conical surface which overlaps the shoulder in the axial direction.

19. The control lever according to claim 18, wherein the shoulder and the conical surface form a rib which extends around the longitudinal axis.

20. The control lever according to claim 16, wherein the knob has a groove formed therein which is open in the first radial direction and is elongated in a second radial direction for receiving the leg.

21. The control lever according to claim 20, wherein the knob further comprises at least one inclined surface extending in a direction between the first and second radial directions and in contact with the leg in the second radial direction after displacement of the actuation section.

22. The control lever according to claim 21, wherein the knob further comprises two opposed inclined surfaces.

23. The control lever according to claim 22, wherein the opposed inclined surfaces form opposite sides of a slot.

24. The control lever according to claim 21, wherein the leg further comprises an axially extending section which cooperates with the inclined surface.

25. The control lever according to claim 16, wherein the locking element comprises an elastic element configured to elastically bend when displaced from the first position to the second position.

26. The control lever according to 16, wherein the locking element comprises a U-shaped element.

27. The control lever according to claim 16, wherein the locking element further comprises two legs which overlap diametrically opposite sections of the shoulder in the first position.

28. The control lever according to claim 27, wherein the actuation section interconnects the two legs such that the locking element is U-shaped.

29. The control lever according to claim 16, wherein the knob has an axially extending groove formed through which the actuation section extends.

30. The control lever according to claim 16, wherein the locking element comprises a metal wire.

31. A control lever for a vehicle, comprising:
a lever shaft defining a longitudinal axis and having a free end and a shoulder which faces away from the free end;
a knob having an axially extending recess to fittingly receive the free end of the lever shaft, a conical surface which overlaps the shoulder in the axial direction such that the shoulder and the conical surface form a rib which extends around the longitudinal axis and a groove formed therein which is open in a first radial direction and is elongated in a second radial direction for receiving the leg; and
an elastic locking element configured to elastically bend when displaced from the first position to the second position for releasably securing the knob on the lever shaft, the locking element having two legs which are held in a first position engaging the shoulder to secure the knob and the lever shaft and an actuation section interconnecting the two legs and accessible on an outer side of the knob for manipulation displacement of the legs, wherein displacement of the actuation section moves the leg in the first radial direction from the first position to the second position in which the leg disengages from the shoulder.
